(19) United States
(12) Patent Application Publication
(10) Pub. No.: US 2025/0158326 A1
(43) Pub. Date: May 15, 2025

(54) CONNECTOR

(71) Applicant: SUMITOMO WIRING SYSTEMS, LTD., Mie (JP)

(72) Inventor: Yutaro YOSHIDA, Mie (JP)

(21) Appl. No.: 18/836,012

(22) PCT Filed: Jan. 26, 2023
(86) PCT No.: PCT/JP2023/002347

§ 371 Date: Aug. 6, 2024

(30) Foreign Application Priority Data
Feb. 10, 2022 (JP) 2022-019446

(51) Int. Cl. H01R 13/629; H01R 13/52

(52) U.S. Cl. CPC H01R 13/62938; H01R 13/5205

(57) ABSTRACT

A connector (10) includes a terminal fitting (16) to be connected to a front end part of a wire (80), a housing (11) for accommodating the terminal fitting (16), a rubber plug (17) arranged in a rear part of the housing (11) and configured to surround an outer periphery of the wire (80) in a liquid-tight manner, a rear holder (14) arranged behind the rubber plug (17) and configured to sandwich the rubber plug (17) between the housing (11) and the rear holder (14), and a lever (15) supported on the housing (11) and configured to connect the housing (11) to a mating housing (91) by being rotated. The lever (15) includes a restricting portion (58) facing the rear holder (14) from behind at a connection position.

### TECHNICAL FIELD

The present disclosure relates to a connector.

### BACKGROUND

Each of connectors disclosed in Patent Document 1 to 4 is provided with a terminal fitting, a housing, a rubber plug, a rear holder and a lever. The terminal fitting is connected to a front end part of a wire and accommodated in the housing. The rubber plug is mounted in a rear part of the housing. The rubber plug surrounds the outer periphery of the wire in a liquid-tight manner. The rear holder is arranged behind the rubber plug. The rubber plug is sandwiched between the housing and the rear holder. The lever is supported rotatably with respect to the housing. The connection of the housing and a mating housing proceeds by the rotation of the lever.

Generally, a rear holder includes a multitude of lock portions lockable to a housing. In the case of Patent Document 1, a pair of claw-like lock portions (called locking projections in Patent Document 1) are formed on each of four side surface portions on the outer periphery of the rear holder. The housing is formed with a plurality of lock holes (called locking portions in Patent Document 1) at positions corresponding to the respective lock portions. The rear holder is held in the housing by fitting each lock portion into each lock hole.

### PRIOR ART DOCUMENT

### Patent Document

Patent Document 1: JP 2005-123102 A
Patent Document 2: JP 2008-078141 A
Patent Document 3: JP 2018-018583 A
Patent Document 4: WO 2014/115363 A1

### SUMMARY OF THE INVENTION

### Problems to be Solved

In the process of assembling the rear holder, each lock portion interferes with an opening edge part of each lock hole in the housing. Thus, interference resistance of each lock portion is added and a work load increases. In contrast, workability can be improved by reducing the number of the lock portions. However, if the number of the lock portions is reduced, it is difficult to stably hold the housing and the rear holder at position(s) where the lock portion(s) is/are omitted.

Accordingly, the present disclosure aims to provide a connector capable of stably holding a housing and a rear holder.

### Means to Solve the Problem

The present disclosure is directed to a connector with a terminal fitting to be connected to a front end part of a wire, a housing for accommodating the terminal fitting, a rubber plug arranged in a rear part of the housing, the rubber plug surrounding an outer periphery of the wire in a liquid-tight manner, a rear holder arranged behind the rubber plug, the rubber plug being sandwiched between the housing and the rear holder, and a lever supported on the housing, the lever connecting the housing to a mating housing by being rotated, the lever including a restricting portion facing the rear holder from behind at a connection position.

### Effect of the Invention

According to the present disclosure, it is possible to provide a connector capable of stably holding a housing and a rear holder.

### BRIEF DESCRIPTION OF THE DRAWINGS

FIG. 1 is a back view of a connector according to one embodiment of the present disclosure.

FIG. 2 is a section along A-A of FIG. 1 of the connector properly connected to a mating connector.

FIG. 3 is a side view of the connector properly connected to the mating connector.

FIG. 4 is a perspective view of a housing.

FIG. 5 is a perspective view of a rear holder.

FIG. 6 is a back view of the rear holder.

FIG. 7 is a perspective view of a lever.

FIG. 8 is a plan view of the connector in which the lever is arranged at a temporary locking position with respect to the housing.

### DETAILED DESCRIPTION TO EXECUTE THE INVENTION

### Description of Embodiments of Present Disclosure

First, embodiments of the present disclosure are listed and described.

(1) The connector of the present disclosure is provided with a terminal fitting to be connected to a front end part of a wire, a housing for accommodating the terminal fitting, a rubber plug arranged in a rear part of the housing, the rubber plug surrounding an outer periphery of the wire in a liquid-tight manner, a rear holder arranged behind the rubber plug, the rubber plug being sandwiched between the housing and the rear holder, and a lever supported on the housing, the lever connecting the housing to a mating housing by being rotated, the lever including a restricting portion facing the rear holder from behind at a connection position.

Since the restricting portion faces the rear holder from behind, a rearward movement of the rear holder with respect to the housing is restricted and the housing and the rear holder can be stably held. Particularly, since the restricting portion is formed on the lever, the complication of the entire configuration can be avoided.

(2) Preferably, the lever includes a pair of cam portions facing each other and a coupling portion coupling the pair of cam portions and is rotatable with respect to the housing to an initial position where the coupling portion is located behind and away from the rear holder and the connection position where the coupling portion is contactably close to the rear holder, and the restricting portions are formed at least on end parts of the pair of cam portions on the coupling portion side.

Even if the rear holder is arranged in a state separated rearward from a proper position with respect to the housing, the restricting portions can push the rear holder to the proper position when the lever reaches the connection position. Particularly, since the restricting portions are formed on the end parts of the pair of cam portions on the coupling portion side, a long distance (moment length) from an axis of rotation to the restricting portions can be ensured. As a result, a large push-in force can be applied to the rear holder.

(3) The restricting portions may be continuously formed in ranges from the end parts of the pair of cam portions on the coupling portion side to the coupling portion. According to the above configuration, coupling parts of the pair of cam portions and the coupling portion can be reinforced by the restricting portions and the rigidity of the lever can be enhanced.

(4) The rear holder may include a recess for receiving the restricting portion at the connection position.

According to the above configuration, it can be avoided that the restricting portion largely projects rearward of the rear holder when the lever is at the connection position. As a result, a dimension in a front-rear direction of the connector can be suppressed.

(5) The rear holder may include four side surface portions on an outer periphery, lock portions to be locked to the housing may be formed on a pair of the side surface portions facing opposite to each other, out of the four side surface portions, and the recesses may be formed in another pair of side surface portions facing opposite to each other, out of the four side surface portions.

According to the above configuration, since the lock portions on the other pair of side surface portions are made unnecessary and a total number of the lock portions can be reduced, assembly resistance of the rear holder can be suppressed to be small. Further, since the lock portions are formed on the pair of side surface portions facing opposite to each other and the recesses are formed in the other pair of side surface portions facing opposite to each other, the housing and the rear holder can be held in a well-balanced manner.

(6) The lever may include a deflectable and deformable lever lock portion for holding the housing and the mating housing in a connected state, and the restricting portion may be arranged at a position facing the lever lock portion in a deflection direction of the lever lock portion.

According to the above configuration, the restricting portion is made less likely to be shifted with respect to the rear holder by the locking action of the lever lock portion

### Details of Embodiment of Present Disclosure

A specific example of the present disclosure is described below with reference to the drawings. Note that the present invention is not limited to this illustration, but is represented by claims and intended to include all changes in the scope of claims and in the meaning and scope of equivalents.

### Embodiment

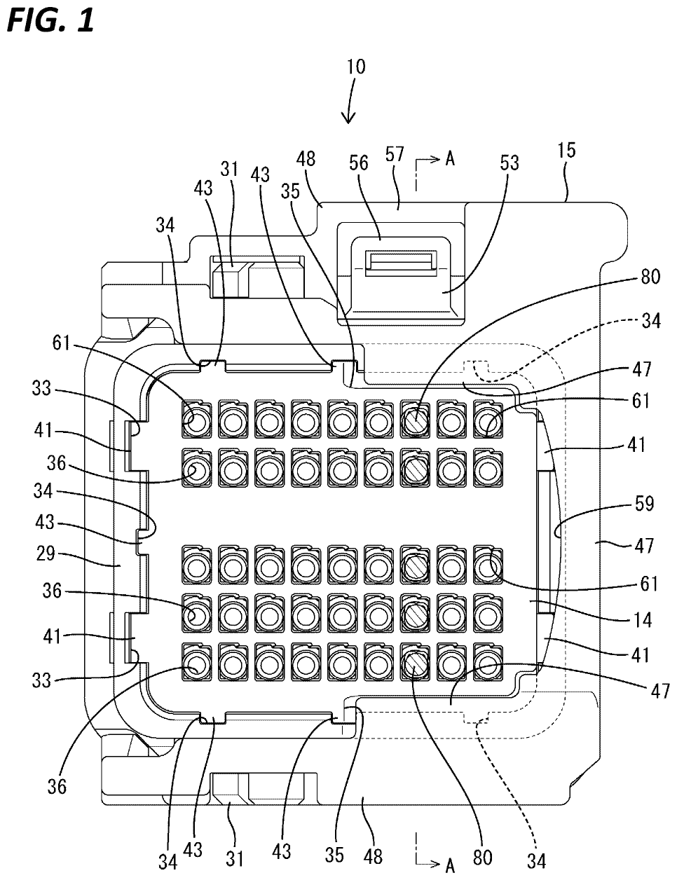

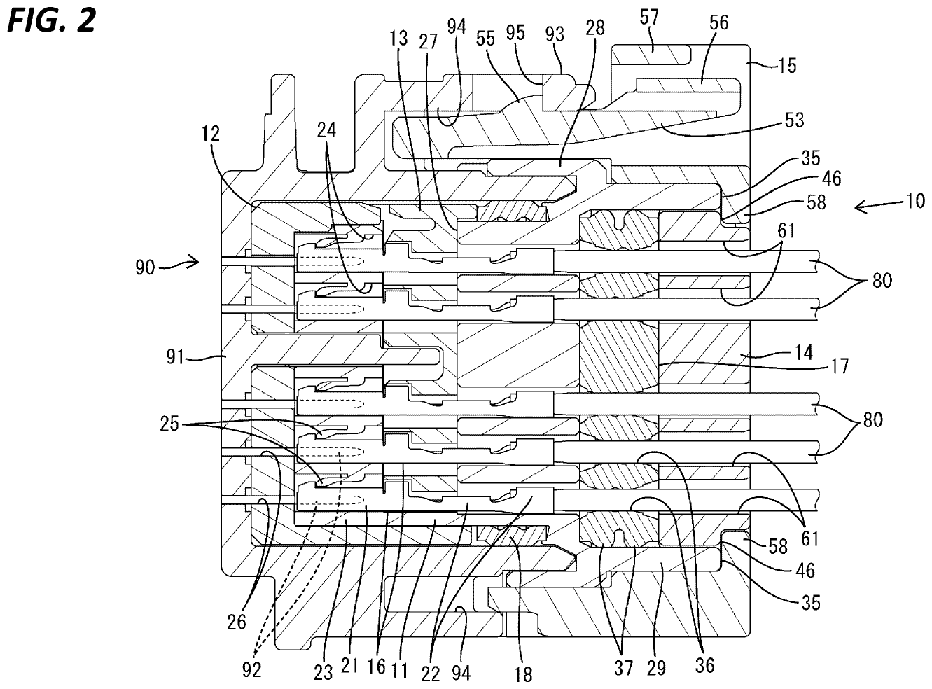

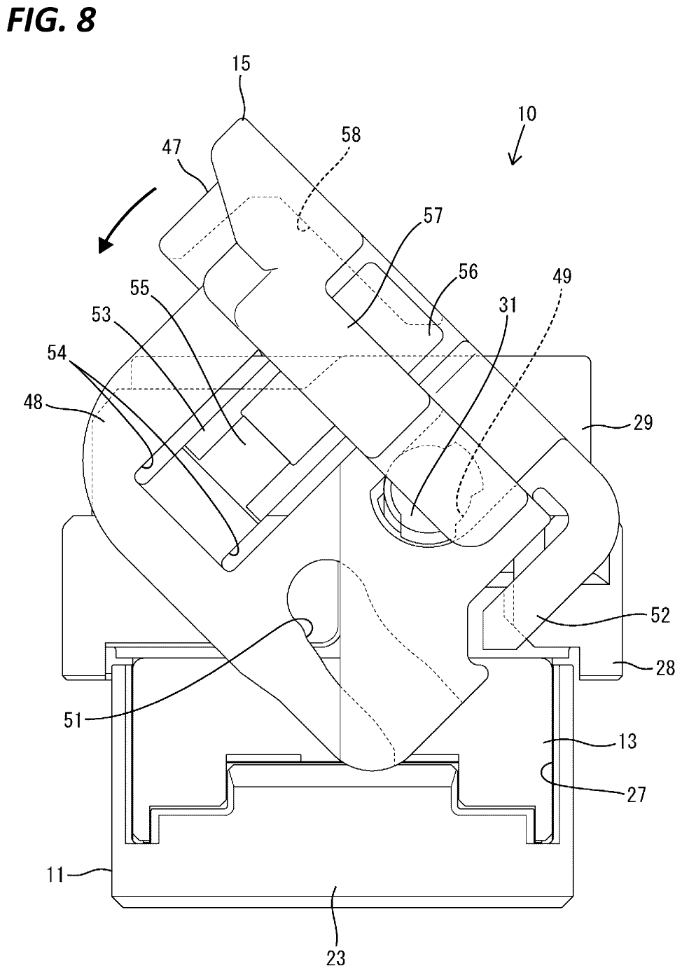

A connector 10 according to one embodiment of the present disclosure is, as shown in FIG. 2, provided with a housing 11, a front holder 12, a retainer 13, a rear holder 14, a lever 15, terminal fittings 16, a rubber plug 17 and a sealing ring 18. The housing 11, the rear holder 14, the lever 15, the retainer 13 and the front holder 12 are made of synthetic resin. The terminal fitting 16 is made of electrically conductive metal. The rubber plug 17 and the sealing ring 18 are made of rubber such as silicon rubber. The connector 10 is connectable to a mating connector 90. Note that, in the following description, surface sides facing each other when the connection of the connector 10 and the mating connector 90 is started are referred to as front sides concerning a front-rear direction. A vertical direction is based on a vertical direction of each figure except FIG. 8. The vertical direction is synonymous with a height direction. The vertical direction is not limited to a direction of gravity when the connector 10 is installed into an unillustrated vehicle or the like. A lateral direction is a lateral direction of FIG. 1 and synonymous with a width direction.

### (Mating Connector)

As shown in FIG. 2, the mating connector 90 is provided with a mating housing 91 made of synthetic resin and mating terminal fittings 92 made of electrically conductive metal. The mating terminal fitting 92 is a pin-shaped or tab-shaped male terminal. The mating housing 91 includes a receptacle 93 in the form of a rectangular tube projecting forward although not shown in detail. A plurality of the mating terminal fittings 92 project into the receptacle 93.

The upper and lower walls of the receptacle 93 have a double wall structure and include accommodation spaces 94 for accommodating later-described cam portions 48 of the lever 15 inside.

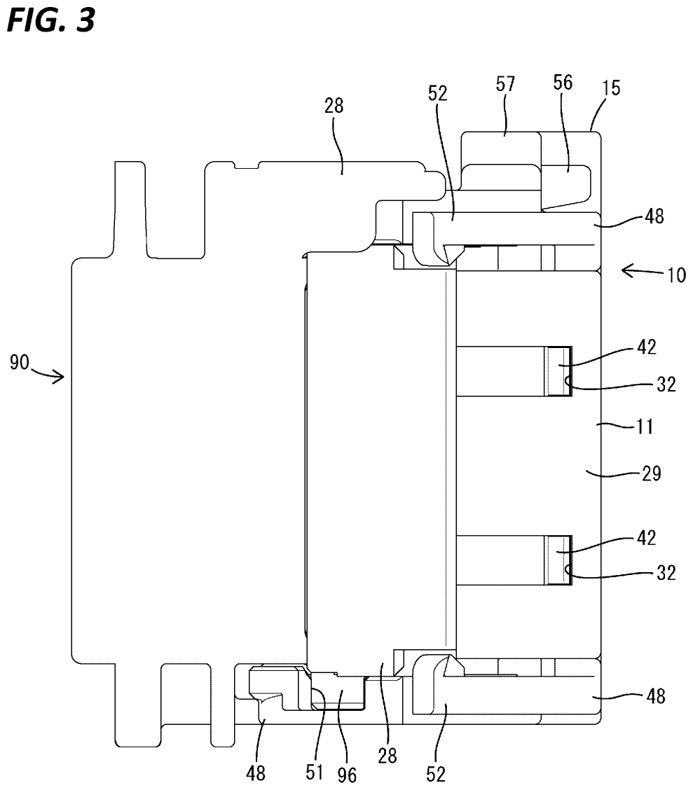

The upper and lower walls of the receptacle 93 include cam pins 96 (shown only on a lower side in FIG. 3) projecting into the accommodation spaces 94 from inner wall parts. As shown in FIG. 2, the upper wall of the receptacle 93 includes a lever lock receiving portion 95 in the form of a hole penetrating through an outer wall part in the vertical direction.

### (Terminal Fitting)

As shown in FIG. 2, the terminal fitting 16 is illustrated as a female terminal elongated in the front-rear direction. The terminal fitting 16 includes a tubular box portion 21 and a barrel portion 22 connected behind the box portion 21. The mating terminal fitting 92 is inserted into the box portion 21 at the time of connecting the connector 10. An unillustrated resilient contact piece to be electrically connected to the mating terminal fitting 92 is formed in the box portion 21. The barrel portion 22 is electrically and mechanically connected to a front end part of a wire 80.

### (Housing, Retainer, Front Holder, Sealing Ring, Rubber Plug)

As shown in FIG. 2, the housing 11 includes a housing body 23 in a front part. The housing body 23 includes a plurality of cavities 24 penetrating in the front-rear direction. The terminal fitting 16 is inserted into each cavity 24 of the housing body 23 from behind. A locking lance 25 is formed to project on the inner wall of each cavity 24. The terminal fitting 16 is locked by the locking lance 25 and primarily retained in the housing body 23.

The front holder 12 is mounted on the housing body 23 from front. The front holder 12 is cap-shaped. The front holder 12 includes a plurality of insertion holes 26. The mating terminal fitting 92 is inserted through each insertion hole 26 of the front holder 12. The sealing ring 18 is mounted on the outer periphery of the housing body 23. The sealing ring 18 is sandwiched between the housing body 23 and the receptacle 93 in a liquid-tight manner. The front holder 12 restricts the sealing ring 18 from coming out forward.

The housing body 23 is formed with a retainer mounting hole 27. The retainer mounting hole 27 is open in the upper surface of the housing body 23 and communicates with each cavity 24. The retainer 13 is inserted into the retainer mounting hole 27 of the housing body 23 from above. The retainer 13 locks the terminal fittings 16. The terminal fittings 16 are secondarily retained in the housing body 23 by the retainer 13.

The housing 11 includes a fitting tube portion 28 surrounding the outer periphery of a rear part of the housing body 23. As shown in FIG. 2, tip parts of the upper and lower walls of the receptacle 93 are fit between the fitting tube portion 28 and the housing body 23.

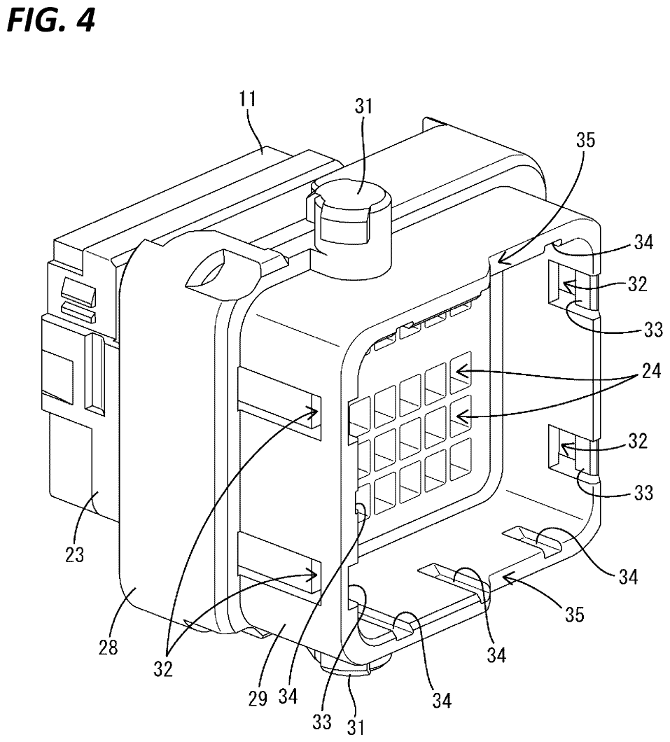

As shown in FIG. 4, the housing 11 includes an assembly portion 29 in the form of a rectangular tube projecting rearward from the housing body 23. The assembly portion 29 is coupled to a base end part of the rear end of the fitting tube portion 28.

As shown in FIGS. 1 and 4, the upper and lower walls of the assembly portion 29 include support shafts 31 respectively projecting downward and upward on one widthwise side (left side of FIG. 1). Each support shaft 31 is a part for rotatably supporting the lever 15.

As shown in FIG. 4, left and right side walls of the assembly portion 29 include a plurality of lock holes 32 penetrating in the lateral direction. The respective lock holes 32 are arranged in pair in the side wall of the assembly portion 29 while being spaced apart in the vertical direction. As shown in FIG. 3, a lock projection 42 of a later-described lock portion 41 of the rear holder 14 is fit into each lock hole 32 from inside. As shown in FIG. 4, a plurality of lock guide portions 33 are provided by recessing the inner surface of each side wall of the assembly portion 29. Each lock guide portion 33 extends in the front-rear direction, communicates with each lock hole 32 and is open rearward of the assembly portion 29. As shown in FIG. 1, the lock portion 41 is fit in each lock guide portion 33.

As shown in FIGS. 1 and 4, a plurality of guide grooves 34 are formed in the inner surface of the assembly portion 29 while being spaced apart in a circumferential direction. Each guide groove 34 extends long in the front-rear direction and is open rearward of the assembly portion 29. A plurality of, three in detail, guide grooves 34 are arranged in each of the upper and lower walls of the assembly portion 29 while being spaced apart in the lateral direction. One remaining guide groove 34 is arranged in the left side wall of FIG. 1 in the assembly portion 29. No guide groove 34 is formed in the right side wall of FIG. 1 in the assembly portion 29. Later-described guide portions 43 of the rear holder 14 are fit into the respective guide grooves 34.

As shown in FIG. 4, the rear end of the assembly portion 29 includes retracted portions 35 retracted forward relative to the one widthwise side on the other widthwise side. As shown in FIG. 1, a later-described coupling portion 47 of the lever 15 can enter and be arranged in the retracted portions 35.

As shown in FIG. 2, the rubber plug 17 is inserted into the assembly portion 29 from behind. The rubber plug 17 is a one-piece rubber plug in the shape of a mat having a thickness in the front-rear direction. The rubber plug 17 includes a plurality of sealing holes 36 penetrating in the front-rear direction. With the rubber plug 17 accommodated in the assembly portion 29, the respective sealing holes 36 and the respective cavities 24 communicate in the front-rear direction. The wire 80 connected to the terminal fitting 16 is inserted through each sealing hole 36 in a liquid-tight manner. The rubber plug 17 includes outer peripheral lips 37 to be held in close contact with the inner periphery of the assembly portion 29 on an outer periphery.

### (Rear Holder)

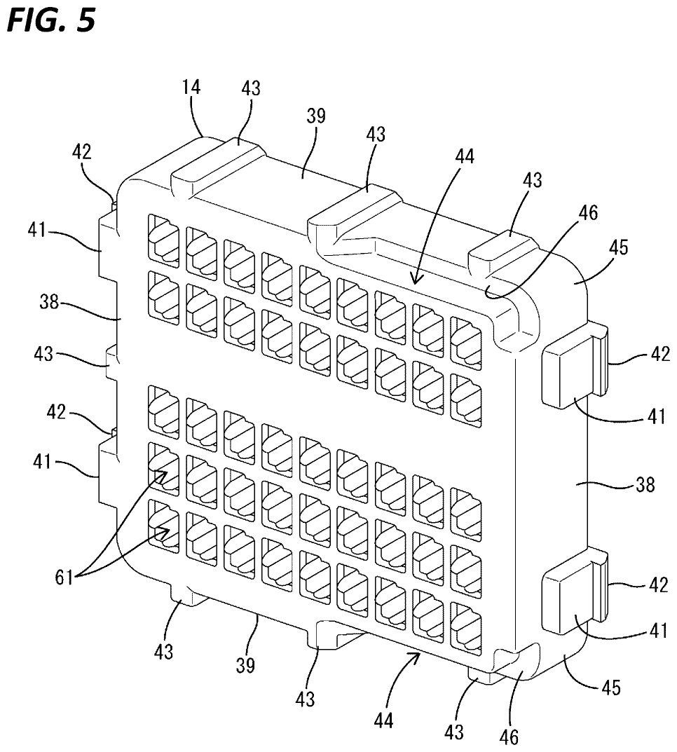

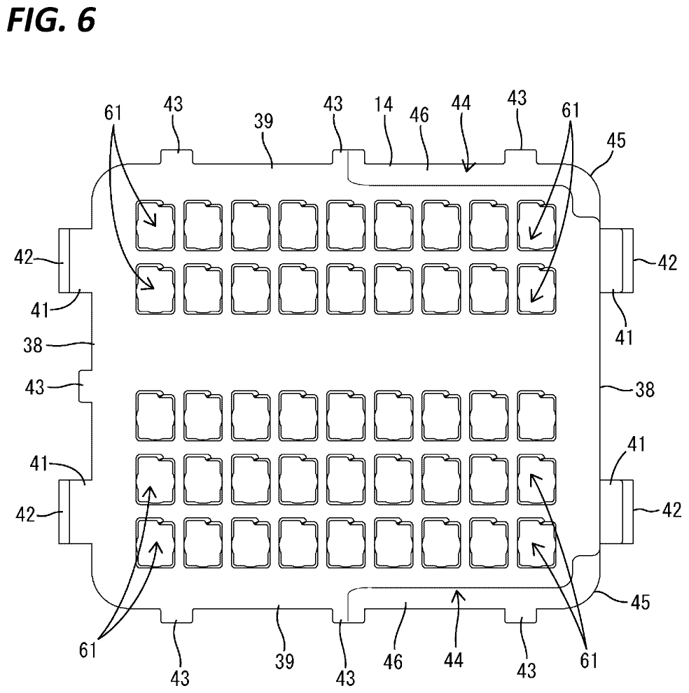

The rear holder 14 is inserted into the assembly portion 29 from behind, following the rubber plug 17 (see FIG. 2). The rear holder 14 has a larger thickness than the rubber plug 17 and includes, as shown in FIGS. 5 and 6, four side surface portions 38, 39 facing upward, downward, leftward and rightward on an outer periphery. Further, the rear holder 14 includes a plurality of through holes 61 penetrating in the front-rear direction. With the rear holder 14 accommodated in the assembly portion 29, the respective through holes 61 communicate with the respective cavities 24 and the respective sealing holes 36 in the front-rear direction as shown in FIG. 2. Each through hole 61 has a rectangular cross-sectional shape and has an opening of such a size that the box portion 21 of the terminal fitting 16 is insertable therethrough.

As shown in FIGS. 5 and 6, a plurality of the lock portions 41 are formed to project on the left and right side surface portions 38 (side surface portions facing opposite to each other in the lateral direction), out of the respective side surface portions 38, 39. Each lock portion 41 has a flat rectangular shape in a side view. The respective lock portions 41 are arranged in pair on each side surface portion 38 while being spaced apart in the vertical direction. The rib-like lock projection 42 extending in the vertical direction is formed to project on a front end part of each lock portion 41.

A plurality of the guide portions 43 are formed to project on the respective side surface portions 38, 39. Each guide portion 43 is in the form of a rib extending long in the front-rear direction. A plurality of, three in detail, guide portions 43 are arranged on each of the upper and lower side surface portions 39 (side surface portions facing opposite to each other in the vertical direction) while being spaced apart in the lateral direction. One remaining guide portion 43 is arranged in a vertical middle part of the left side surface portion 38 of FIG. 6. No guide portion 43 is formed on the right side surface portion 38 of FIG. 6.

A recess 44 is formed in each of the upper and lower side surface portions 39, out of the respective side surface portions 38, 39. Out of the recesses 44, the upper recess 44 is provided on the other widthwise side (right side of FIG. 6) in the upper side surface portion 39 and is open not only upward of the rear holder 14, but also rearward and rightward of the rear holder 14. The lower recess 44 is provided on the other widthwise side in the lower side surface portion 39 and is open not only downward of the rear holder 14, but also rearward and rightward of the rear holder 14. An end part of each recess 44 on the other widthwise side is open in a corner portion 45 in the form of a curved surface arranged between the side surface portions 38 and 39.

Each recess 44 has a facing surface 46 on an end surface on a back side in a recess direction toward a front side. The facing surface 46 is a perpendicular surface along the vertical direction and arranged to face rearward. The facing surface 46 is arranged along the lateral direction except on an end part on one widthwise side. The end part on the one widthwise side of the facing surface 46 is arranged obliquely to the front-rear direction and lateral direction. The facing surface 46 of each recess 44 is arranged to face a later-described restricting surface of the lever 15. The middle and right guide portions 43 of FIG. 6 on the upper and lower side surface portions 39 are partially cut by the respective recesses 44 and the cut rear surfaces are connected to the facing surfaces 46 without any step.

### (Lever)

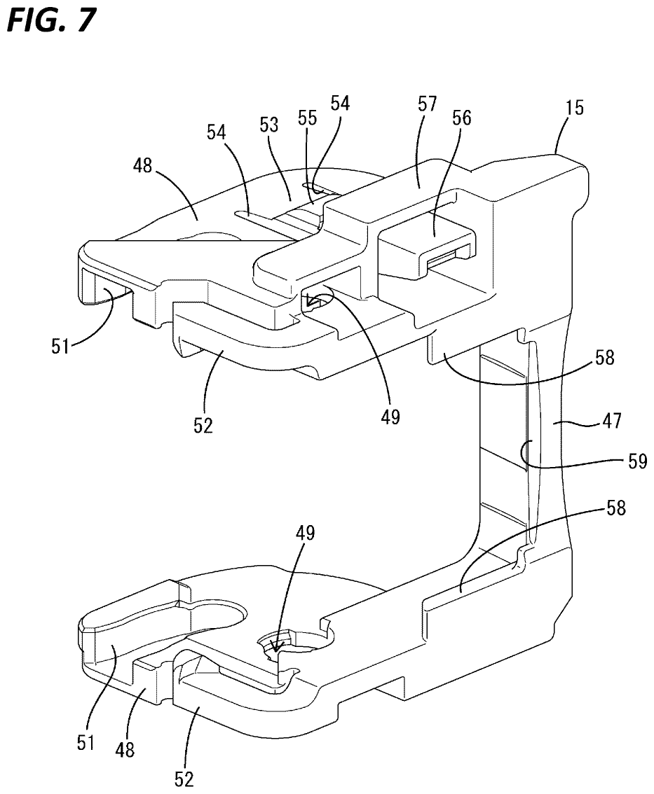

As shown in FIG. 7, the lever 15 is gate-shaped and includes the coupling portion 47 extending in the vertical direction and a pair of the cam portions 48 projecting in parallel from upper and lower end parts of the coupling portion 47. Each cam portion 48 is plate-like and includes a shaft hole 49 penetrating in the vertical direction (plate thickness direction). Each cam portion 48 is formed with a cam groove 51. Each cam groove 51 is open in an end part on one widthwise side distant from the coupling portion 47 on the outer periphery of each cam portion 48.

The lever 15 is supported rotatably to an initial position (see FIG. 8) and a connection position (see FIGS. 1 to 3) with respect to the housing 11 about the support shafts 31 fit in the respective shaft holes 49. At the initial position, the coupling portion 47 is arranged behind and away from the rear holder 14 as shown in FIG. 8. At the connection position, the coupling portion 47 is proximately arranged to be able to contact the rear holder 14. A rotating operation of the lever 15 can be performed by pinching the coupling portion 47 with fingers.

As shown in FIG. 7, each cam portion 48 includes a temporary locking portion 52 on the end part on the one widthwise side. The temporary locking portion 52 has a cantilever shape extending along the outer periphery of the cam portion 48. As shown in FIG. 8, tip sides of the temporary locking portions 52 are locked to the front end of the fitting tube portion 28, whereby the lever 15 is held at the initial position with respect to the housing 11.

Out of the respective cam portions 48, the upper cam portion 48 includes a lever lock portion 53. The lever lock portion 53 is arranged deflectably and deformably between a pair of slits 54 formed in the upper cam portion 48. The lever lock portion 53 includes a projection 55 projecting upward. When the lever 15 is at the connection position, the lever lock portion 53 is locked to the lever lock receiving portion 95 of the mating housing 91 as shown in FIG. 2. The lever lock portion 53 includes a releasing portion 56 arranged to be higher on a rear end part. By pushing the releasing portion 56 from above, the locking of the lever lock portion 53 and the lever lock receiving portion 95 is released. The upper cam portion 48 includes a protecting portion 57 surrounding the outer periphery of the releasing portion 56 in a rear end part. The releasing portion 56 contacts the upper and lower protecting portions 57, thereby restricting excessive deflection and deformation of the lever lock portion 53.

As shown in FIG. 7, the lever 15 includes a plurality of restricting portions 58 on a rear end. The respective restricting portions 58 project inward (toward mutually facing sides of the respective cam portions 48) from end parts on the other widthwise sides on the rear ends of the respective cam portions 48. Each restricting portion 58 is in the form of a rectangular plate long in the width direction. An end part of each restricting portion 58 is connected to the coupling portion 47. The upper restricting portion 58 is integrally coupled to the protecting portion 57. That is, the upper restricting portion 58 is arranged at a position facing the lever lock portion 53 in a deflection direction of the lever lock portion 53. As shown in FIG. 1, the coupling portion 47 has an arched surface 59 curved toward the other widthwise side on an inner surface part between the respective restricting portions 58.

### (Connector Assembly Structure and Connection Structure)

In assembling the connector 10, the rubber plug 17 is inserted into the assembly portion 29 of the housing 11 from behind. Subsequently, the rear holder 14 is inserted into the assembly portion 29 of the housing 11 from behind. In the process of inserting the rear holder 14, the respective guide portions 43 are fit into the respective guide grooves 34, whereby an inserting operation of the rear holder 14 is guided. In this way, it can be avoided that the rear holder 14 is inclined with respect to the housing 11.

Further, in the process of inserting the rear holder 14, the lock projections 42 of the respective lock portions 41 slide in the respective lock guide portions 33 and the left and right side walls of the assembly portion 29 are deformed to bulge outward. When the insertion of the rear holder 14 is completed, the left and right side walls of the assembly portion 29 return to original shapes and the lock projections 42 of the respective lock portions 41 are fit into the respective lock holes 32. In this way, the rear holder 14 is held in the assembly portion 29. If the rear holder 14 is properly assembled with the housing 11, the front surface of the rear holder 14 is arranged along the rear surface of the rubber plug 17 (see FIG. 2). The facing surfaces 46 of the respective recesses 44 of the rear holder 14 are arranged at the same position as the retracting portions 35 of the assembly portion 29 in the front-rear direction.

In connecting the connector 10 and the mating connector 90, the lever 15 is first arranged at the initial position (see FIG. 8). In that state, the housing 11 is lightly fit in the receptacle 93 of the mating housing 91. Then, the tip part of the upper wall of the receptacle 93 interferes with the temporary locking portion 52 and the temporary locking portion 52 is deflected and deformed in a direction to release the locking with the fitting tube portion 28. In this way, the lever 15 is enabled to rotate to the connection position.

Further, at the initial position, the upper cam portion 48 is inserted into the accommodation space 94 and the cam pin 96 enters the entrance of the cam groove 51. Subsequently, the lever 15 is rotated toward the connection position. In the process of rotating the lever 15 toward the connection position, the cam pins 96 slide on the groove surfaces of the cam grooves 51 and a connecting operation of the connector 10 and the mating connector 90 proceeds. When the lever 15 reaches the connection position, the projection 55 of the lever lock portion 53 is fit into the lever lock receiving portion 95 and the connector 10 and the mating connector 90 are properly connected as shown in FIG. 2. At this time, the respective terminal fittings 16 and the respective mating terminal fittings 92 are properly connected. As shown in FIG. 1, the coupling portion 47 of the lever 15 is arranged to contactably face the right side wall of FIG. 1 in the assembly portion 29 from behind. The arched surface 59 of the coupling portion 47 can avoid strong interference with the respective wires 80 pulled out from the respective through holes 61 of the rear holder 14.

Further, with the lever 15 located at the connection position, the respective restricting portions 58 of the lever 15 are entirely inserted in the respective recesses 44 of the rear holder 14. Here, the front surfaces of the respective restricting portions 58 are arranged to contactably face the facing surfaces 46 of the respective recesses 44 and the retracted portions 35 (see FIG. 2). In this state, the rear end surface of the lever 15 is arranged at the same position as the rear surface (except the recesses 44) of the rear holder 14 in the front-rear direction. Subsequently, the terminal fitting 16 connected to the front end part of the wire 80 is inserted into each cavity 24 of the housing 11. Each terminal fitting 16 can be mounted from behind the connector 10 by an automatic machine since the rear end positions of the rear holder 14 and the lever 15 are aligned.

The rear holder 14 is so arranged that the respective lock portions 41 are locked into the respective lock holes 32 of the housing 11 in both end parts in the lateral direction and the respective restricting portions 58 face the facing surfaces 46 of the respective recesses 44 in both end parts in the vertical direction. Thus, the rear holder 14 is reliably restricted from coming out from the assembly portion 29. Particularly, since the upper and lower walls of the assembly portion 29 do not include the lock guide portions 33 and the lock holes 32, these walls need not be thick in the vertical direction. Further, in this embodiment, a wire cover and the like are not mounted on the rear part of the housing 11 and the lever 15 does not project rearward of the rear holder 14. As a result, the enlargement of the connector 10 can be avoided.

If a rear end part of the rear holder 14 protrudes rearward from the inside of the assembly portion 29, the respective restricting portions 58 press the facing surfaces 46 of the respective recesses 44 and the rear holder 14 can be brought to a proper assembly position in the assembly portion 29 when the lever 15 reaches the connection position.

As described above, according to this embodiment, the respective restricting portions 58 face the facing surfaces 46 of the respective recesses 44 from behind, whereby a rearward movement of the rear holder 14 with respect to the housing 11 can be restricted. As a result, the housing 11 and the rear holder 14 can be stably held. Particularly, since the restricting portions 58 are formed on the lever 15, the complication of the entire configuration can be avoided.

Further, since each restricting portion 58 is formed on the end part of each cam portion 48 on the side of the coupling portion 47, a long distance (moment length) from the support shaft 31 to the restricting portion 58 can be ensured. As a result, a large push-in force can be given from the lever 15 to the rear holder 14.

Further, each restricting portion 58 is continuously formed in a range from the end part of each cam portion 48 on the side of the coupling portion 47 to the coupling portion 47. Thus, a coupling part (corner part) of each cam portion 48 and the coupling portion 47 can be reinforced by each restricting portion 58, and the rigidity of the lever 15 can be enhanced.

Further, each restricting portion 58 is inserted into each recess 44 of the rear holder 14 at the connection position. In the case of this embodiment, each restricting portion 58 is entirely inserted into each recess 44. Thus, each restricting portion 58 does not project rearward of the rear holder 14 and a dimension in the front-rear direction of the connector 10 can be suppressed.

Further, the rear holder 14 includes the four side surface portions 38, 39 on the outer periphery, the lock portions 41 to be locked to the respective 11 are respectively formed on the left and right side surface portions 38 and the recesses 44, into which the restricting portions 58 are inserted, are formed in the upper and lower side surface portions 39, out of the four side surface portions 38, 39. Thus, the lock portions 41 on the upper and lower side surface portions 39 are made unnecessary, a total number of the lock portions 41 can be reduced, and assembly resistance of the rear holder 14 can be suppressed to be small. Moreover, the housing 11 and the rear holder 14 can be held in a well-balanced manner in the vertical direction and lateral direction.

Furthermore, since the upper restricting portion 58 is arranged at the position facing the lever lock portion 53 in the deflection direction of the lever lock portion 58, the upper restricting portion 58 is less likely to be shifted with respect to the rear holder 14.

### Other Embodiments of Present Disclosure

The embodiment disclosed this time should be considered illustrative in all aspects, rather than restrictive.

In the case of the above embodiment, the restricting portion is formed on each of the pair of cam portions. However, as another embodiment, a restricting portion may be formed on only one of the pair of cam portions. Further, a restricting portion may be formed on the coupling portion of the lever. Furthermore, only one restricting portion may be formed on the lever.

In the case of the above embodiment, the restricting portion is inserted into the recess at the connection position. However, as another embodiment, the rear holder may not be formed with the recess and the restricting portion may be merely arranged to face the rear surface (facing surface) of the rear holder from behind at the connection position.

In the case of the above embodiment, the restricting portion contacts the facing surface of the rear holder at the connection position. However, as another embodiment, the restricting portion may be arranged behind and away from the facing surface of the rear holder at the connection position.

### LIST OF REFERENCE NUMERALS

10 connector
11 housing
12 front holder
13 retainer
14 rear holder
15 lever
16 terminal fitting
17 rubber plug
18 sealing ring
21 box portion
22 barrel portion
23 . . . housing body
24 . . . cavity
25 . . . locking lance
26 . . . insertion hole
27 . . . retainer mounting hole
28 . . . fitting tube portion
29 . . . assembly portion
31 . . . support shaft
32 . . . lock hole
33 . . . lock guide portion
34 . . . guide groove
35 . . . retracted portion
36 . . . sealing hole
37 . . . outer peripheral lip
38 . . . left, right side surface portion
39 . . . upper, lower side surface portion
41 . . . lock portion
42 . . . lock projection
43 . . . guide portion
44 . . . recess
45 . . . corner portion
46 . . . facing surface
47 . . . coupling portion
48 . . . cam portion
49 . . . support shaft
51 . . . cam groove
52 . . . temporary locking portion
53 . . . lever lock portion
54 . . . slit
55 . . . projection
56 . . . releasing portion
57 . . . protecting portion
58 . . . restricting portion
59 . . . arched surface
61 . . . through hole
80 . . . wire
90 . . . mating connector
91 . . . mating housing
92 . . . mating terminal fitting
93 . . . receptacle
94 . . . accommodation space
95 . . . lever lock receiving portion
96 . . . cam pin

1. A connector, comprising:
a terminal fitting to be connected to a front end part of a wire;
a housing for accommodating the terminal fitting;
a rubber plug arranged in a rear part of the housing, the rubber plug surrounding an outer periphery of the wire in a liquid-tight manner;
a rear holder arranged behind the rubber plug, the rubber plug being sandwiched between the housing and the rear holder; and
a lever supported on the housing, the lever connecting the housing to a mating housing by being rotated,
the lever including a restricting portion facing the rear holder from behind at a connection position.

2. The connector of claim 1, wherein:
the lever includes a pair of cam portions facing each other and a coupling portion coupling the pair of cam portions and is rotatable with respect to the housing to an initial position where the coupling portion is located behind and away from the rear holder and the connection position where the coupling portion is contactably close to the rear holder, and
the restricting portions are formed at least on end parts of the pair of cam portions on the coupling portion side.

3. The connector of claim 2, wherein the restricting portions are continuously formed in ranges from the end parts of the pair of cam portions on the coupling portion side to the coupling portion.

4. The connector of claim 1, wherein the rear holder includes a recess for receiving the restricting portion at the connection position.

5. The connector of claim 4, wherein:
the rear holder includes four side surface portions on an outer periphery,
lock portions to be locked to the housing are formed on a pair of the side surface portions facing opposite to each other, out of the four side surface portions, and
the recesses are formed in another pair of side surface portions facing opposite to each other, out of the four side surface portions.

6. The connector of claim 1, wherein:
the lever includes a deflectable and deformable lever lock portion for holding the housing and the mating housing in a connected state, and
the restricting portion is arranged at a position facing the lever lock portion in a deflection direction of the lever lock portion.
